(19) United States
(12) Patent Application Publication
(10) Pub. No.: US 2015/0174970 A1
(43) Pub. Date: Jun. 25, 2015

(54) PNEUMATIC VEHICLE TIRE

(71) Applicant: Continental Reifen Deutschland GmbH, Hannover (DE)

(72) Inventors: Daniel Baeuning, Hannover (DE); Andreas Domscheit, Hannover (DE)

(21) Appl. No.: 14/640,888

(22) Filed: Mar. 6, 2015

Related U.S. Application Data
(63) Continuation of application No. PCT/EP2013/065859, filed on Jul. 29, 2013.

(30) Foreign Application Priority Data
Sep. 7, 2012 (DE) 10 2012 108 343.6

(51) Int. Cl. B60C 19/12

(52) U.S. Cl. CPC B60C 19/122

(57) ABSTRACT

A self-sealing pneumatic vehicle tire defines a tire circumference. The self-sealing pneumatic vehicle tire includes a belt assembly having a first width and defining a projection. A tread is arranged radially above the belt assembly and an airtight inner layer is arranged radially inwardly. A sealant layer applied radially internally after the pneumatic vehicle tire has been vulcanized has a second width approximately equal to the first width. The sealant layer is arranged approximately within the projection and defines an area radially above the sealant layer around the tire circumference. The inner layer is configured as a two part layer such that the inner layer does not lie approximately radially above the sealant layer in this area.

### CROSS REFERENCE TO RELATED APPLICATIONS

This application is a continuation application of international patent application PCT/EP2013/065859, filed Jul. 29, 2013, designating the United States and claiming priority from German application 10 2012 108 343.6, filed Sep. 7, 2012, and the entire content of both applications is incorporated herein by reference.

### FIELD OF THE INVENTION

The invention relates to a self-sealing pneumatic vehicle tire having a belt assembly, a tread arranged radially above the belt assembly, and a radially internally arranged, airtight inner liner. The self-sealing of the pneumatic vehicle tire is obtained by means of a sealant layer which is subsequently applied radially internally after vulcanization of the pneumatic vehicle tire. The sealant layer has approximately the width of the belt assembly and is arranged approximately in the projection thereof.

### BACKGROUND OF THE INVENTION

Such pneumatic vehicle tires of self-sealing configuration are, for example, known from DE 10 2006 059 286 A1. In this case, standard tire configurations are provided subsequently with a sealant layer. The sealant is a self-adhesive viscous sealing compound which is applied as a layer to the radially innermost tire ply in the projection region of the belt assembly. The innermost tire ply is a largely airtight inner liner. The sealant layer is capable of independently sealing penetrations of up to five millimeters in diameter. After the tread has been penetrated as far as the inner liner, the sealant completely surrounds the foreign body which has penetrated, seals the interior off from the surroundings and thus prevents a loss of compressed air from the tire. The driver of the vehicle is not compelled to replace the defective tire immediately with a full spare wheel or an emergency wheel also referred to as a donut type tire.

The sealant is used by the applicant under the name ContiSeal®. The sealant is distinguished by airtightness, high adhesion and balanced flow behavior.

There is a continuous effort to save costs on materials in tire production without negatively affecting the properties of the tire.

### SUMMARY OF THE INVENTION

It is an object of the invention to provide a self-sealing pneumatic vehicle tire with which costs for materials in tire production are saved without negatively affecting the properties of the tire.

The object is achieved by embodying the inner liner in 2 parts such that no inner liner is arranged approximately radially above the sealant layer around the tire circumference.

The pneumatic vehicle tire according to the invention has an inner liner which is cut away or not disposed above the sealant, that is, the inner liner is absent above the sealant. The sealant is inherently airtight, and therefore no inner liner is required in the region of the sealant in order to establish the airtightness of the pneumatic vehicle tire. Thus, the inner liner is made of two parts running around the circumference which establish the airtightness of the tire outside the sealant layer. The inner liner is usually produced from (halo)butyl rubber. By omitting the inner liner above the sealant layer, there is a saving of materials and costs.

It is advantageous if those edges of the sealant layer which face the inner liner are arranged so as to overlap with the inner liner. This ensures airtightness even in the range of production tolerances.

It is practical if the width of the overlap of the sealant layer with the inner liner is approximately 2 mm to 30 mm, preferably approximately 10 mm.

### BRIEF DESCRIPTION OF THE DRAWING

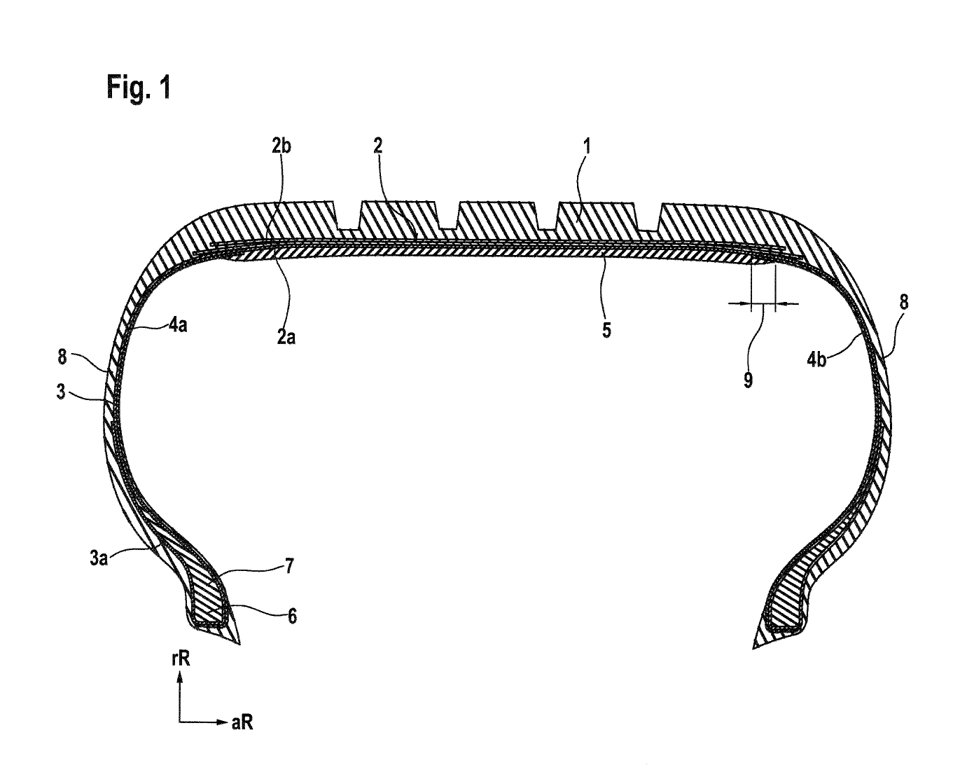

The invention will now be described with reference to the single FIGURE of the drawing (FIG. 1) which shows a cross section through a pneumatic vehicle tire according to the invention having a sealant layer.

### DESCRIPTION OF THE PREFERRED EMBODIMENTS OF THE INVENTION

The essential components of which the self-sealing tire according to the invention is made are: a profiled tread 1; a belt assembly 2, which is made of two plies (2a, 2b) in the embodiment shown; a single-ply carcass 3, which is passed around the bead cores 6 and bead core profiles 7 from the inside axially to the outside axially and ends in the carcass turnup 3a; and, side walls 8. The two plies (2a, 2b) of the belt assembly 2 are made of steel cord reinforcements embedded in a rubber compound, which extend parallel to one another within each ply. The steel cords of one ply 2a are oriented in a crosswise arrangement relative to the steel cords of the second ply 2b and each enclose an angle of between 15° and 45° with the circumferential direction of the tire. The single-ply carcass 3 can also be embodied in a conventional and known manner and can thus have radially extending reinforcing filaments made of a textile material or of steel cord embedded in a rubber compound.

The self-sealing of the pneumatic vehicle tire is obtained via a sealant layer 5 subsequently applied radially internally after vulcanization of the pneumatic vehicle tire. The sealant layer 5 has approximately the width of the belt assembly 2 and is arranged approximately in the projection thereof. The inner liner (4a, 4b) is embodied in 2 parts such that no inner liner is arranged approximately radially above the sealant layer 5 around the tire circumference. Those edges of the sealant layer 5, which face the inner liner (4a, 4b), are arranged so as to overlap with the inner liner (4a, 4b) wherein the sealant layer 5 covers the edges of the inner liner (4a, 4b). The width of the overlap 9 of the sealant layer 5 with the inner liner (4a, 4b) is approximately 2 mm to 30 mm, preferably approximately 10 mm, measured in the axial direction.

It is understood that the foregoing description is that of the preferred embodiments of the invention and that various changes and modifications may be made thereto without departing from the spirit and scope of the invention as defined in the appended claims.

### LIST OF REFERENCE SIGNS

(Part of the description)
1 tread
2 belt assembly
2a belt ply
2b belt ply
3 carcass
3a carcass turnup
4a inner liner
4b inner liner
5 sealant layer
6 bead core
7 bead core profile
8 side wall
9 width of the overlap
rR radial direction
aR axial direction

What is claimed is:

1. A self-sealing pneumatic vehicle tire defining a tire circumference, the self-sealing pneumatic vehicle tire comprising:
a belt assembly having a first width and defining a projection;
a tread arranged radially above said belt assembly;
an airtight inner layer arranged radially inwardly;
a sealant layer applied radially internally after the pneumatic vehicle tire has been vulcanized;
said sealant layer having a second width approximately equal to said first width;
said sealant layer being arranged approximately within said projection and defining an area radially above said sealant layer around said tire circumference; and,
said inner layer being configured as a two part layer so as to cause said area to be devoid of said inner layer approximately radially above said sealant layer.

2. The self-sealing pneumatic vehicle tire of claim 1, wherein:
said two part layer is made up of first and second layer parts;
said sealant layer has edges facing corresponding ones of said first and second layer parts; and,
said first and second layer parts are arranged to overlap with corresponding ones of said edges of said sealant layer to define respective overlap regions.

3. The self-sealing pneumatic vehicle tire of claim 2, wherein each of said overlap regions has a width lying in a range of approximately 2 mm to 30 mm.

4. The self-sealing pneumatic vehicle tire of claim 2, wherein each of said overlap regions has a width of approximately 10 mm.
